(19) United States
(12) Patent Application Publication
(10) Pub. No.: US 2014/0301073 A1
(43) Pub. Date: Oct. 9, 2014

(54) LINEAR LED LIGHTING DEVICE, SYSTEM, METHOD, AND APPARATUS

(71) Applicant: Lynk Labs, Inc., Elgin, IL (US)

(72) Inventor: Michael Miskin, Sleepy Hollow, IL (US)

(73) Assignee: Lynk Labs, Inc., Elgin, IL (US)

(21) Appl. No.: 14/197,997

(22) Filed: Mar. 5, 2014

Related U.S. Application Data
(60) Provisional application No. 61/851,311, filed on Mar. 5, 2013.

(51) Int. Cl. F21K 99/00; F21V 23/00

(52) U.S. Cl. CPC F21K 9/50; F21V 23/00
USPC 362/235; 362/249.06

(57) ABSTRACT

A linear LED lighting system having at least one LED circuit formed on a PCB assembly, the at least one LED circuit and PCB assembly forming an LED PCB assembly. The linear LED lighting system includes at least one housing for housing the LED PCB assembly, the at least one housing and the LED PCB assembly, wherein the at least one housing is a piece of trim. The linear LED lighting system is capable of providing light distribution over a linear distance of at least 12 inches, and is configured on a first side to be mounted to a surface.

### RELATED APPLICATIONS

The application claims priority to U.S. Provisional Application No. 61/851,311 filed Mar. 5, 2013—the contents of which are expressly incorporated herein by reference.

### TECHNICAL FIELD

The present invention generally relates to light emitting diode (“LED”) lamps, and more specifically to linear LED lighting devise and systems integrated behind or within molding and/or trim that is made of solid or flexible material.

### FEDERALLY SPONSORED RESEARCH OR DEVELOPMENT

None.

### BACKGROUND OF THE INVENTION

LEDs are semiconductor devices that produce light when a voltage and current is supplied to them. LEDs are intrinsically DC devices that only pass current in one polarity. Historically LEDs have been driven by constant current or constant voltage DC. More recently, new inventions have demonstrated that LEDs may also be driven direct with low voltage AC or high voltage AC, and with low voltage and high voltage rectified AC.

The increasing adoption and advancement of LED technology has resulted in the development of new LED lighting devices and LED lamps which may replace legacy lamps or light bulbs. Linear LED lighting is becoming more popular as LEDs continue to improve in efficiency and cost. LEDs are directional lights and mostly provide direction lighting in the products they are incorporated in. Optics, reflectors, diffusers, and light pipes are sometimes used to control the direction and/or beam distribution of the LED light source.

LEDs are small light sources and can be integrated into smaller profile fixtures and/or locations. LED lighting, in some cases, may enable lighting to be integrated within locations that lighting was previously not possible or more challenging to integrate.

The present invention provides a solution and new use for integrating LED lighting into areas where integrated lighting was previously difficult or impossible.

The present invention is provided to solve these and other issues.

### SUMMARY OF THE INVENTION

The present invention is directed to a linear LED lighting system which is capable of allowing integration of a light fixture into small profile areas, and in particular areas which are bounded or covered by trim.

According to one aspect of the invention, a linear LED lighting system having an LED printed circuit board (“PCB”) assembly having at least one LED circuit formed on a PCB assembly is provided. The LED PCB assembly is housed within at least one housing, the at least one housing and the LED PCB assembly forming an LED light fixture which may be capable of providing light distribution over a linear distance of at least 12 inches. The linear LED lighting system also includes a cover element. The LED light fixture is configured on a first side to be mounted to a surface, and is configured on a second side to allow the cover element to be integrated with the LED light fixture, the LED light fixture and the cover element being configured so that the cover element is mounted to the surface to which the LED light fixture is mounted.

Each LED PCB assembly may include at least one connector located at a first end of the LED PCB assembly. This connector may be capable of providing both an electrical and mechanical connection between the LED PCB assembly and an electrical connector formed as part of the lighting fixture through which electrical power may be provided, or to a second LED PCB assembly housed within the same housing as the LED PCB assembly. In order to provide power to the LED PCB assembly, the light fixture may include an electrical connector for connecting to a source of electrical power. At least a second electrical connector configured to provide an electrical connection between the light fixture and/or the LED PCB assembly to a source of power or an additional LED lighting PCB assembly may be provided too.

The LED PCB assembly may further include at least a second LED circuit electrically connected to the at least one LED circuit on the PCB assembly. Any number of additional LED circuits may be integrated on the PCB assembly and electrically connected to each other to form the LED PCB assembly.

The cover element which may integrate with the LED light fixture may be a piece of trim or a molding used. In order to accommodate some configurations or locations, the light fixture and any PCB assembly housed within may be flexible. In order to accommodate different lengths, the LED PCB assembly may be scalable in length.

The at least one LED circuit formed on the PCB assembly may include at least two LEDs connected in a series relationship, at least two LEDs connected in an anti-parallel relationship, a bridge rectifier having at least one LED connected across the outputs of the bridge rectifier, an imbalanced bridge rectifier having at least one LED connected across the outputs of the imbalanced bridge rectifier, or any combination thereof. For example, two branches of at least two LEDs connected in series may be connected in an anti-parallel configuration or the like.

The linear LED lighting system may include a heat sink which is thermally connected to the at least one LED PCB assembly. The linear LED lighting system may also include one or more of an optical diffuser, an optical film, or a lens mounted over at least one LED forming the at least one LED circuit.

According to one aspect of the invention, a linear LED lighting system having an LED PCB assembly having at least one LED circuit formed on a PCB assembly is provided. The linear lighting system includes at least one housing for housing the LED PCB assembly, the at least one housing being formed as a piece of trim or molding. The linear LED lighting system may be capable of providing light distribution over a linear distance of at least 12 inches. The linear LED lighting system may be configured to be mounted to a surface on a first side.

The linear LED lighting system may also include at least one electrical connector formed in an exterior surface of the housing or trim for connecting the LED light fixture to a source of power. The lighting system may include at least a second electrical connector formed in the exterior of the housing or trim, the at least second electrical connector being configured to provide an electrical connection of the LED light fixture to a source of power or an additional LED light fixture.

The at least one LED circuit formed on the PCB assembly and as part of the LED light fixture and linear LED lighting system, may include at least two LEDs connected in a series relationship, at least two LEDs are connected in an anti-parallel relationship, a bridge rectifier having at least one LED connected across the outputs of the bridge rectifier, an imbalanced bridge rectifier having at least one LED connected across the outputs of the imbalanced bridge rectifier, or any combination thereof. For example, two branches of at least two LEDs connected in series may be connected in an anti-parallel configuration or the like.

The linear LED lighting system may also include a heat sink which is thermally connected to the at least one LED PCB assembly. The heat sink may be separate or formed as part of the housing or trim. The LED light fixture may also be flexible, and the linear LED lighting system may include one or more of an optical diffuser, an optical film, or a lens.

According to one aspect of the invention, a kit for providing trim and lighting is provided. The kit includes at least one piece of trim capable of being mounted to a surface, and at least one LED PCB assembly having at least one LED circuit integrated on a PCB assembly. A housing for the LED PCB assembly, the housing being configured to allow the LED PCB assembly and at least one piece of trim to be integrated to form a trim element wherein both the housing and the trim element are mounted to the surface.

The LED PCB assembly in the kit may include a heat sink integrated within the housing and being thermally connected to the at least one LED PCB assembly.

The housing may form a light fixture which has a form for allowing the light fixture to be attached to the surface between the trim and the surface so as to form a spacer between the trim and the surface. The housing may be formed within the at least one piece of trim, or may be formed separately for integration with the at least one piece of trim.

The at least one piece of trim may include at least one connector which will allow the at least one piece of trim to mechanically connect to at least a second piece of trim, and electrically connect the at least one piece of trim and the at least one LED PCB assembly to a source of power or at least a second LED PCB assembly.

Other advantages and aspects of the present invention will become apparent upon reading the following description of the drawings and detailed description of the invention.

### BRIEF DESCRIPTION OF THE DRAWINGS

FIG. 1 shows a front view of an embodiment of a lighting system;

FIG. 2 shows a top view of an embodiment of an LED PCB assembly;

FIG. 3 shows a top view of an embodiment of an LED PCB assembly;

FIG. 4 shows an embodiment of a circuit;

FIG. 5a shows an embodiment of a circuit;

FIG. 5b shows an embodiment of a circuit;

FIG. 6 shows an embodiment of a circuit;

FIG. 7 shows an embodiment of a circuit;

FIG. 8 shows an embodiment of a circuit;

FIG. 9 shows a side view of an embodiment of an LED PCB assembly;

FIG. 10 shows a top view of an embodiment of a lighting fixture;

FIG. 11 is a cross-section along the line X-X in FIG. 10;

FIG. 12 shows a top view of FIG. 1 using the light fixture embodiment shown in FIGS. 10 and 11;

FIG. 13 shows a back view of an embodiment of the lighting system shown in FIG. 1; and

FIG. 14 shows a top view of the lighting system shown in FIG. 13.

### DETAILED DESCRIPTION OF PREFERRED EMBODIMENTS

While this invention is susceptible to embodiments in many different forms, there is described in detail herein, preferred embodiments of the invention with the understanding that the present disclosures are to be considered as exemplifications of the principles of the invention and are not intended to limit the broad aspects of the invention to the embodiments illustrated.

FIG. 1 shows an embodiment of a linear LED lighting system 10 as contemplated by the invention. As seen in FIG. 1, lighting system 10 includes a cover element 12 mounted to a surface 14 with light 16 emanating from behind cover element 12. Light 16 may emanate from at least one LED circuit integrated on a printed circuit board (“PCB”) forming at least one LED PCB assembly. As explained further herein, the LED PCB assembly may be separately housed from the cover element, for example to form a light fixture, or the cover element may form or include a housing for the LED PCB assembly. Regardless of how the LED PCB assembly is housed, fasteners 18 may be used to fasten cover element 12 to surface 14, through the LED PCB assembly and any additional housing.

Cover element 12 may be trim or molding used to connect to, construct, accent, or decorate surface 14 which may be for example, a wall, floor, ceiling, door jamb, window, furniture, game table or machine, or other fixture. Trim or molding may include cut, milled, extruded, formed, stamped, or co-extruded trim or molding. Such trim or molding may include crown molding, chair rail, base mold, wall trim, cove trim, or decorative or functional trim for walls, floors ceilings, furniture elements, or game tables. It should be understood that any form of trim or molding may be utilized in lighting system 10 as cover element 12.

Linear LED lighting system 10 and any affiliated housing is provided to allow for lighting in the area proximate any trim or molding by having light emit from between the trim or molding and the surface to which the trim or molding attaches. As discussed herein, this may be accomplished utilizing two configurations.

The first configuration includes a light fixture having an LED PCB assembly housed inside a housing, with a cover like a piece of trim or molding fixed thereto. Both the light fixture and the trim will mount to the surface to which the trim is to be mounted to, like for example a wall, with the light fixture and trim or molding forming an integrated lighting system by virtue of being mounted in an overlapping manner. In such an arrangement, the light fixture may act as a spacer between the trim and the surface, or the trim may have a recess or the like for the housing to integrate with.

In a second configuration, the cover element or trim or molding includes a housing for housing an LED PCB assembly therein to form the lighting system. In this configuration, the housing, cover element, and piece of trim or molding are a single body which act as both the desired trim and the housing for the LED PCB assembly. In this configuration, the trim may include any required recesses or apertures, lenses, transparent or translucent edges or sides, or other optic elements to allow light from the LED PCB assembly housed therein to emit outside the trim.

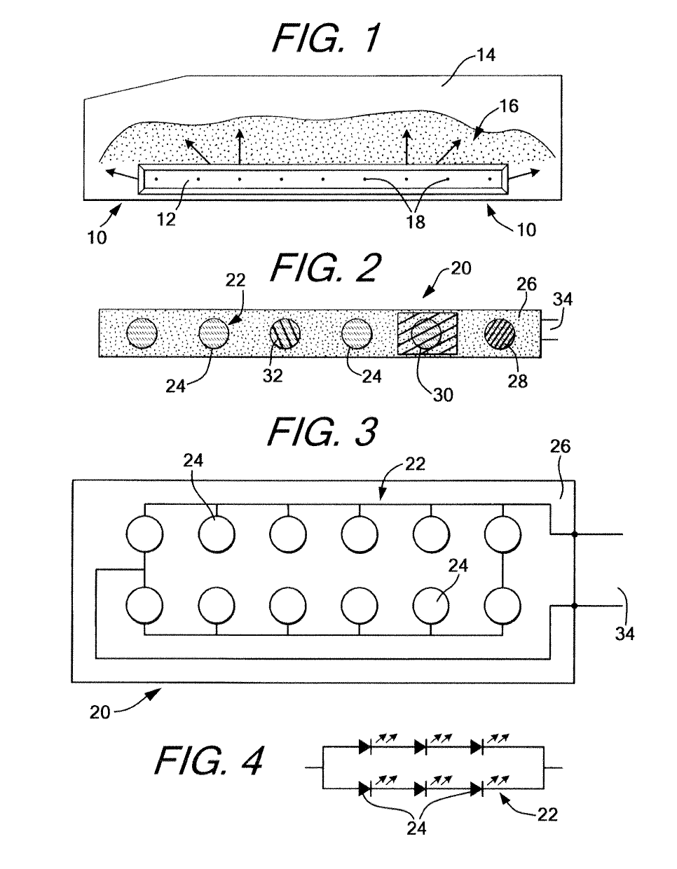

FIGS. 2 and 3 show embodiments of an LED PCB assembly utilized with linear LED lighting system 10. LED PCB assembly 20 includes at least one LED circuit 22 formed using LEDs 24 which are integrated on PCB assembly 26. LED PCB assembly 20 may include various optics or elements for angling, focusing, or diffusing any light emanating from LEDs 22, including but not limited to, optical diffuser 28, optical film 30, or lens 32. Any optics or other elements may be incorporated into the LED PCB assembly, or alternatively, may be formed as part of a housing utilized with the LED PCB assembly, whether the housing is formed as a part of the cover element 12 or as a separate body.

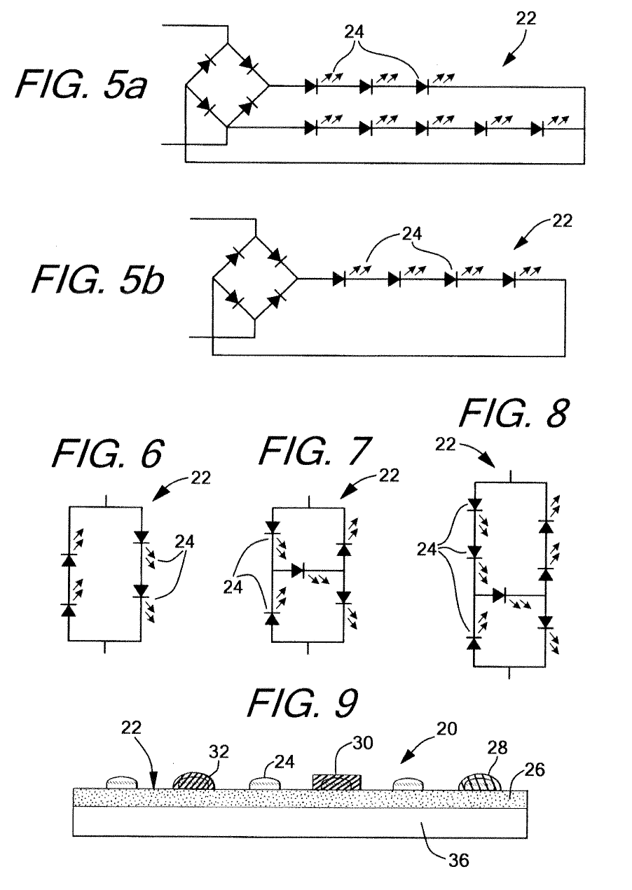

LED circuit 22 may include any number of LEDs 24 and which may be configured to operate utilizing AC power, DC power, or both. FIGS. 4-8 show exemplary embodiments of circuits which may be integrated on PCB assembly 26 for use with the present invention. These circuits may be configured for use with direct or rectified DC power (FIG. 4 for example), or for use with provided AC power through the use of a bridge or imbalanced bridge configuration and LEDs connected across the outputs of the bridge or imbalanced bridge (FIGS. 5a, 5b, 7, and 8) or through an anti-parallel connection (FIG. 6). The LEDs may be configured to emit white light through the use of any optics elements or phosphor, or may alternatively be configured to emit colored light, either directly from the LEDs, or again through the use of optics or phosphors. Where multiple series strings are connected in parallel, like for example in FIG. 5a, the LED PCB assembly may be capable of emitting light of different colors and have the capability to warm-on-dim as described, for example, in International Pat. Pub. No. 2013/082609 to Lynk Labs, Inc., the contents of which are expressly incorporated herein by reference. As explained therein, providing series strings of LEDs having different color outputs and forward operating voltages based either on the number of LEDs in each string and/or the operating characteristics of the LEDs in each string, and utilizing a dimmer switch to control the voltage and current provided to the series strings, allows for the color temperature of the light output from the totality of the LEDs, and consequently the LED PCB assembly and light fixture and system, to be controlled.

In addition to potentially being different colors, it is contemplated by the invention that the LEDs may be regular or organic LEDs, and the LED circuits may be formed directly on the PCB assembly or by integrating discretely packaged LEDs on the PCB assembly. The LED PCB assembly may also be formed as a chip-on-board type package have electrical connectors which will allow the at least one LED circuit formed therein to be connected to any electrical connection provided by the lighting system.

In either configuration, the lighting system may be sold as an integrated formed unit, or as a kit which allows an end user to configure and size the cover, trim, and LED PCB assembly as desired.

As seen in FIGS. 2 and 3, LED PCB assembly 20 may also include at least one connector 34 which may be used to mechanically and/or electrically connect LED PCB assembly 20 to any housing or an additional LED PCB assembly formed within the same housing. Connector 34 may, for example, connect to a plug or cord formed in an exterior portion of a housing for the LED PCB assembly for receiving power from a power source or supply. Alternatively, connector 34 may, for example, connect to a connector on a different LED PCB assembly. In order to provide for both, it is contemplated by the invention that connectors 34 may be connected to both sides of LED PCB assembly 20. Connector 34 may be a plug, or a set of electric or voltage input leads or contacts, a simple set of wires, a plug receptacle, or any known means of providing at least an electrical connection.

PCB assembly 26 may include any required wiring or conductivity traces required to connect LEDs 24 in the desired circuit arrangement and connect the circuit arrangement to connector 34 so that the received power is provided to the LEDs and LED circuit 22. Where desired or necessary, the wires or traces may connect LEDs 22 into multiple circuits which are electrically connected to each other on the PCB assembly. For example, LEDs 24 in FIG. 3 may be connected into two anti-parallel circuits having three LEDs in series in each branch, or an anti-parallel circuit and a bridge circuit having two LEDs across the output.

In order to match different forward operating voltages, match a particular light output, or accommodate a particular length or configuration, LED PCB assembly may be scalable to particular lengths. For example, LED PCB assembly 20 in FIGS. 2 and 3 may be cut off after three LEDs to provide a smaller, lower brightness, lower voltage LED PCB assembly. In order to accommodate the scaling, the LED PCB assembly may include wires or traces which permit cutting or scaling after each LED so that a closed or complete circuit will exist, or connector 34 may be provided at the end of each LED PCB assembly to complete or close the circuit.

FIG. 9 shows a side view of an embodiment of LED PCB assembly 26 for use in lighting system 10 where a heat sink 36 is thermally attached to the LED PCB assembly. Heat sink 36 may be attached directly to LED PCB assembly 26 before being housed in a separate housing or within trim or cover element 12, or may be formed as part of the housing or cover element or trim.

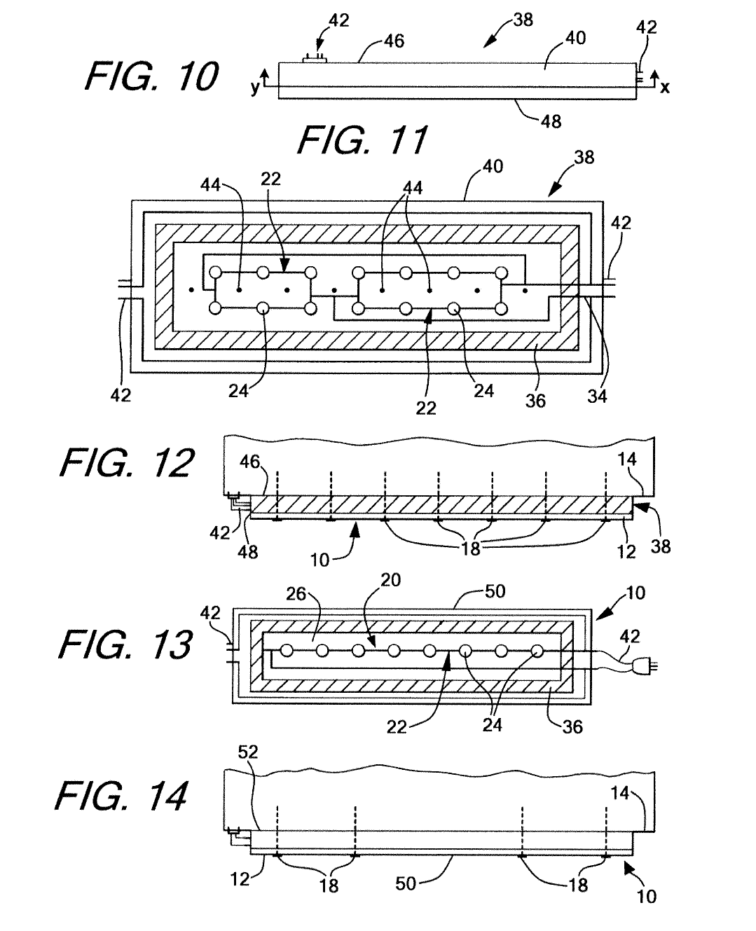

FIGS. 10 and 11 show an embodiment of a light fixture for use in linear LED lighting system 10 having LED PCB assembly housed in a housing separate from cover element 12. As seen FIGS. 10 and 11, LED light fixture 38 includes housing 40 is linearly formed and includes at least one electrical connector 42 which forms an electrical connector for the lighting system 10 and allows LED PCB 20 to connect to a power source, like mains power, a driver or power supply, or to another light fixture in a string of lighting fixtures. In order to both connect to a source of power and another light fixture, or two light fixtures in a string of light fixtures, at least a second electrical connector may be provided. Where two electrical connectors are included, the electrical connectors may be connected to each other so as to allow power received at one electrical connector to be provided at the second electrical connector. Alternatively, LED PCB 20 and LED circuit 22 may be electrically connected to each electrical connector so that power may be provided via each connector through the LED circuit.

As shown in FIG. 10, for example, connector 42 may be a plug or plug receiving element. Connector 42 may also be a power cord or a pair of wires, for example. The placement of connectors 42 may also vary based on configuration or design requirements. For example, rather than be located in the back of housing 40, connectors 42 may be located in an end of the housing, as seen in FIG. 11 which is a cross-section of FIG. 10 along the line X-X. As seen in FIG. 11 and described above, heat sink 36 may also be formed within housing 38.

Housing 40 may permit light emitting from LED PCB assembly 20 to escape and diffuse into the area proximate the housing using known methods. For example, housing 40 may include apertures or holes which allow light to escape there through, or may have at least one fully or partially transparent or translucent side or edge, or may have at least one side or edge formed using a lens or diffuser or optic to diffuse or concentrate or otherwise alter the light. Light fixture 38 should be configured, with any lens, diffusers, or optics formed as part of housing 40 or on LED PCB assembly 20, to be capable of providing light distribution over a linear distance of at least 12 inches.

In order to allow the cover element to attach to the surface to which the linear LED lighting system attaches to, as seen in FIG. 11, the LED PCB assembly and housing 40 may include apertures 44 so a fastener can pass through light fixture, including the housing and LED PCB assembly, without effecting any wires or tracing on the PCB assembly, or any LEDs, and allow the cover element to attach to the surface. Alternatively, no aperture may be provided and the housing and PCB assembly may be constructed using materials which will allow a fastener to pass there through without affecting the integrity or damaging either element.

FIG. 12 shows a top view of linear LED lighting system 10 shown in FIG. 1, including cover element 12, utilizing light fixture 38 in FIGS. 10 and 11. As shown in FIG. 12, LED light fixture 38 has a first side 46 which is configured to be mounted to surface 14. Second side 48 is configured to allow cover element 12 to integrate therewith. In this configuration, LED light fixture 38 acts as a spacer for cover element or trim 12 from surface 14. As explained above, LED light fixture 38 is configured so that fasteners 18 can extend through LED light fixture 38 to connect or mount cover element 12 directly to surface 14. Though not shown in FIG. 12, it is contemplated by the invention that cover element 12 may be configured so that a top portion or a bottom portion of LED light fixture 38 is surrounded to prevent light from emitting on one side or the other of cover element 12.

FIG. 13 shows another embodiment of linear LED lighting system 10 in FIG. 1. As seen in FIG. 13, which is a back view of light fixture or lighting system 10 of an embodiment of lighting system 10 in FIG. 1, LED PCB assembly 20 and heat sink 36 may all be integrated within housing 50, which is or includes cover element 12, all of which may be formed as a piece of trim or molding. Electrical connectors 42 may be formed within or in an exterior surface of housing 50 and LED PCB assembly may connect thereto using connectors 34, as described with respect to housing 40. The electrical connectors may be utilized to connect to a power source, like for example mains power or a power supply or driver, or to another linear LED lighting system in a string of linear LED lighting systems to receive power therefrom or provide power thereto.

When housed within housing 50, which may be a piece of trim or molding, the back side or bottom of housing 50 may be open or partially open to allow light from the LED PCB assembly to be diffused as desired. Alternatively, as with housing 40, the back wall, or a portion of the back wall or an edge or other side or the top or bottom of housing or piece of trim 50 may include apertures, an optic, diffuser, lens, or may be partially translucent or completely transparent to allow light to pass through. Like housing 40, housing 50 and any housed LED PCB assembly may either include apertures or be constructed from a material which will allow fasteners to pass there through without affecting the at least one LED circuit formed on the LED PCB assembly, the PCB assembly, or the housing or piece of trim 50.

FIG. 14 shows a top view of the linear LED lighting system 10 shown in FIG. 13. In this top view, a first side 52 of housing 50 is configured to be mounted to surface 14. The second side of housing 50 is formed as cover 12 which may be a piece of trim or molding.

Regardless of whether housing 40 or 50 is utilized, housing 40 and 50, and internal elements like heat sinks, PCB assemblies, or the like may all be flexible to allow the lighting system 10 to be utilized in areas which require flex or shaping.

It is further contemplated by the invention that linear LED lighting system 10 may include a driver which may be integrated and formed as part of the LED PCB assembly, or separately packaged and formed within the lighting system. The driver may be configured to receive power received by connector 42 or the housing and system, and alter or modify the power as needed. The driver may then provide the power to LED PCB assembly by outputting a voltage and current to connectors 34. Such a driver may be any known driver capable of driving or controlling the LED PCB assembly, and may include, for example, components capable of rectifying an AC voltage to provide DC voltage, any transformers or electronic transformers to step a provided voltage and/or frequency up or down, any required microcontrollers, transistors, or operational amplifiers, any required inverters, any current limiting or controlling devices, like for example constant current regulators, constant current diodes, resistors, or variable resistors, and any current or voltage smoothing elements like capacitors or inductors. The driver may be matched to a particular LED circuit formed on the LED PCB assembly so as to provide a near ideal amount of power at a desired frequency.

While each of these elements may be sold separately, it is contemplated by the invention that any LED PCB assembly and housing in the form of a piece of trim, or any LED PCB assembly housed in a separate housing and a cover element or piece of trim, and any required drivers, may be sold together as a kit to provide trim and lighting or an LED lighting system. The elements provided within the kit may be substantially similar to those discussed herein, with an installer having the option to install the trim and any additional housing or LED PCB assembly as desired.

While in the foregoing there has been set forth various embodiments of the invention, it is to be understood that the present invention may be embodied in other specific forms without departing from the spirit or central characteristics thereof. The present embodiments, therefore, are to be considered in all respects as illustrative and not restrictive, and the invention is not to be limited to the details given herein. While specific embodiments have been illustrated and described, numerous modifications come to mind without significantly departing from the characteristics of the invention and the scope of protection is only limited by the scope of the accompanying claims.

What is claimed is:

1. A Linear LED lighting system comprising:
at least one LED circuit formed on a PCB assembly, the at least one LED circuit and PCB assembly forming an LED PCB assembly;
at least one housing for housing the LED PCB assembly, the at least one housing and the LED PCB assembly forming an LED light fixture, the LED light fixture being capable of providing light distribution over a linear distance of at least 12 inches; and
a cover element,
wherein the LED light fixture is configured on a first side to be mounted to a surface, and is configured on a second side to allow the cover element to be integrated with the LED light fixture, the LED light fixture and the cover element being configured so that the cover element is mounted to the surface to which the LED light fixture is mounted.

2. The linear LED lighting system of claim 1 further comprising at least one connector, the at least one connector located at a first end of the LED PCB assembly.

3. The linear LED lighting system of claim 1 further comprising at least a second LED circuit, the at least second LED circuit being electrically connected to the at least one LED circuit on the PCB assembly.

4. The linear LED lighting system of claim 1 wherein the cover element is a piece of trim.

5. The linear LED lighting system of claim 1 wherein the cover element is a molding.

6. The linear LED lighting system of claim 1 comprising at least one electrical connector.

7. The linear LED lighting system of claim 1 wherein the light fixture is flexible.

8. The linear LED lighting system of claim 1 wherein the LED PCB assembly is scalable in length.

9. The linear LED lighting system of claim 1 wherein the at least one LED circuit includes at least two LEDs connected in a series relationship.

10. The linear LED lighting system of claim 1 wherein the at least one LED circuit includes at least two LEDs are connected in an anti-parallel relationship.

11. The linear LED lighting system of claim 1 wherein the at least one LED circuit includes a bridge rectifier, the bridge rectifier having at least one LED connected across the outputs of the bridge rectifier.

12. The linear LED lighting system of claim 1 wherein the at least one LED circuit includes an imbalanced bridge rectifier, the imbalanced bridge rectifier having at least one LED connected across the outputs of the imbalanced bridge rectifier.

13. The linear LED lighting system of claim 1 further comprising a heat sink, the heat sink being thermally connected to the at least one LED PCB assembly.

14. The linear LED lighting system of claim 6 further comprising at least a second electrical connector, the at least second electrical connector being configured to provide an electrical connection between the LED PCB assembly to a source of power or an additional LED lighting PCB assembly.

15. The linear LED lighting device of claim 1 further comprising an optical diffuser.

16. The linear LED lighting device of claim 1 further comprising an optical film.

17. The linear LED lighting device of claim 1 further comprising a lens.

18. A Linear LED lighting system comprising:
at least one LED circuit formed on a PCB assembly, the at least one LED circuit and PCB assembly forming an LED PCB assembly;
at least one housing for housing the LED PCB assembly, wherein the at least one housing is a piece of trim;
the linear LED lighting system being capable of providing light distribution over a linear distance of at least 12 inches,
wherein the housing is configured on a first side to be mounted to a surface.

19. The linear LED lighting system of claim 18 further comprising at least one electrical connector, the at least one electrical connector being formed in an exterior surface of the housing for connecting the LED light fixture to a source of power.

20. The linear LED lighting system of claim 18 wherein the at least one LED circuit includes at least two LEDs connected in a series relationship.

21. The linear LED lighting system of claim 18 wherein the at least one LED circuit includes at least two LEDs are connected in an anti-parallel relationship.

22. The linear LED lighting system of claim 18 wherein the at least one LED circuit includes a bridge rectifier, the bridge rectifier having at least one LED connected across the outputs of the bridge rectifier.

23. The linear LED lighting system of claim 18 wherein the at least one LED circuit includes an imbalanced bridge rectifier, the imbalanced bridge rectifier having at least one LED connected across the outputs of the imbalanced bridge rectifier.

24. The linear LED lighting system of claim 18 further comprising a heat sink, the heat sink being thermally connected to the at least one LED PCB assembly.

25. The linear LED lighting system of claim 19 further comprising at least a second electrical connector formed in the exterior of the housing, the at least second electrical connector being configured to provide an electrical connection of the LED light fixture to a source of power or an additional LED lighting device.

26. The linear LED lighting device of claim 18 further comprising an optical diffuser.

27. The linear LED lighting device of claim 18 further comprising an optical film.

28. The linear LED lighting device of claim 18 further comprising a lens.

29. A kit for providing trim and lighting, the kit comprising:
at least one piece of trim capable of being mounted to a surface;
at least one LED PCB assembly, the at least one LED PCB assembly having at least one LED circuit integrated on a PCB assembly;
a housing for the LED PCB assembly, the housing allowing for the LED PCB assembly and at least one piece of trim to be integrated so that both are mounted to the surface.

30. The kit of claim 29 further comprising a heat sink, the heat sink being integrated within the housing and being thermally connected to the at least one LED PCB assembly.

31. The kit of claim 29 wherein the housing forms a light fixture, the light fixture having a form allowing the light fixture to be attached to the surface between the trim and the surface so as to form a spacer between the trim and the surface.

32. The kit of claim 29 wherein the housing is formed within the at least one piece of trim.

33. The kit of claim 29 wherein the at least one piece of trim includes at least one connector, the at least one connector allowing the at least one piece of trim to mechanically connect to at least a second piece of trim, and electrically connect the at least one LED PCB assembly to a source of power or at least a second. LED PCB assembly.
